(19) United States
(12) Patent Application Publication
(10) Pub. No.: US 2007/0072018 A1
(43) Pub. Date: Mar. 29, 2007

(54) Chemical reaction device and fuel cell system

(76) Inventors: Masahiro Kuwata, Kawasaki-shi (JP); Fuminobu Tezuka, Yokohama-shi (JP); Yuusuke Sato, Tokyo (JP); Yoshiyuki Isozaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/387,970

(22) Filed: Mar. 24, 2006

(30) Foreign Application Priority Data
Sep. 28, 2005 (JP) 2005-285083

(51) Int. Cl. H01M 8/06; B01J 19/00

(52) U.S. Cl. 429/19; 422/240

(57) ABSTRACT

There is disclosed a chemical reaction device which distributes reaction fluid through a microchannels having convex and concave portions. The chemical reaction device includes an anodized film for supporting a catalyst, convex and concave portions covered with the anodized film to define microchannel wall members, a curved convex corner disposed in the convex portion, and a curved concave corner disposed in the concave portion.

### CROSS-REFERENCE TO RELATED APPLICATIONS

This application is based upon and claims the benefit of priority from prior Japanese Patent Application No. 2005-285083, filed Sep. 29, 2005, the entire contents of which are incorporated herein by reference.

### BACKGROUND OF THE INVENTION

1. Field of the Invention

The present invention relates to a chemical reaction device having a microchannel structure which supports a catalyst to generate a catalytic reaction, and a fuel cell system which generates power by using hydrogen modified by the chemical reaction device.

2. Description of the Related Art

Recently, compact reactors called microreactors having very small reaction flow paths (microchannels) of millimeter units or less therein have actively been developed. Because of its compact shape, the microreactor is not only suitable for a compact device such as a portable information device, but also has the following advantages (1) to (3) described in Jpn. Pat. Appln. KOKAI No. 2003-88754 (paragraphs 0006 and 0031 of Patent Document 1), the entire of which are incorporated herein by reference.

(1) As reaction volume of the reaction flow path becomes small, effect of surface area/volume ratio becomes conspicuous, and heat transmission characteristics during catalytic reaction are improved to increase reaction efficiency.

(2) As diffusion mixing time of reactive molecules constituting a mixture is shortened, progress speed (reaction speed) of the catalytic reaction in the reaction flow path is increased.

(3) Formation of plural layers of configurations including reaction flow paths eliminates the necessity of burdensome and complex reaction engineering studies for scaling-up (increases in device size and production efficiency of fluids).

A method of manufacturing such a microreactor is described in Jpn. Pat. Appln. KOKAI No. 2003-301295 (Patent Document 2), the entire of which are incorporated herein by reference. According to Patent Document 2, a very small flow path structure (microchannel) is formed on an aluminum substrate by a photoetching technology or machining, a porous oxide film is formed in a wall surface of the microchannel by anodizing, and a catalyst is supported on this porous oxide film (support).

However, according to the conventional method, a variance occurs in thickness of oxide films formed during anodizing, and cracks easily occur in portions varied in film thickness as shown in FIGS. 7A and 7B. When cracks occur, destruction of the anodized film progresses starting from the cracks, and a base metal (aluminum) is melted from the destroyed part of the film, disabling a microchannel wall member to function as a flow path wall. Consequently, not only a reduction occurs in manufacturing yield of the microchannel but also corrosion resistance of the microchannel wall member is insufficient after its actual incorporation in the microreactor, causing a problem in reliability of the reaction system.

The cracks of the oxide film mostly occur in a high current density state during anodizing. In particular, it is considered that cracks occur in the microchannel wall member (catalyst support) incorporated in the microreactor because a real area is larger than an apparent area generating a need to conduct a current of a high density equal to or higher than the apparent area. Specifically, in the case of anodizing aluminum, probability of the occurrence of the aforementioned problem is increased when current density becomes excessive. At such a high current density, pore diameter is enlarged and the film becomes hard. Hence, in the case of the high current density, supporting amount of the catalyst support is smaller as compared with that in the case of a low current density.

To suppress the problem which occurs in the case of the high current density, there is a method of reducing the current density during anodizing. However, when the current density is reduced, an erosion speed of the film becomes relatively large as compared with generation speed of the anodized film. Consequently, much time is expended for forming the microchannel wall member (catalyst support).

### BRIEF SUMMARY OF THE INVENTION

It is therefore an object of the present invention to provide a chemical reaction device having a microchannel structure of high mass productivity suited to miniaturization.

According to a an aspect of the present invention, there is provided a chemical reaction device, comprising: a microchannel wall member having a surface at least a part of which is made of a material to be anodized, and having a plurality of adjacent to each other; an anodized film formed in at least a part of the concave portions; a container having a mounting section disposed in order to mount the microchannel wall member thereto; a cover mounted on the container to seal the mounting section; a supply port through which a fluid is supplied; and a discharge port through which the fluid is discharged. Microchannels are formed, by mounting the microchannel wall member to the mounting section and sealing the mounting section with the cover, define the microchannels, in which the fluid supplied through the supply port is discharged through the discharge port after being passed through the microchannels; and in a corner of each of a bottom and an opening of the concave portions, an interface between the microchannel wall member and the anodize film is formed into a curved shape as seen from a passage direction of the fluid of the microchannels.

According to an another aspect of the present invention, there is provided a fuel cell system, comprising: a fuel tank which stores a fluid fuel; a reformer having a chemical reaction device to reform the fluid fuel sent from the fuel tank; and a fuel cell system which includes an anode, a proton conductive semipermeable membrane, and a cathode, and introduces a gas modified by the chemical reaction device to the anode and air to the cathode to generate power. The chemical reaction device comprises a microchannel wall member having a surface at least a part of which is made of a material to be anodized, and having a plurality of concave portions adjacent to each other, an anodized film formed in at least a part of the concave portions, a container having a mounting section disposed in order to mount the microchannel wall member thereto, a cover mounted on the container to seal the mounting section, a supply port through which a fluid is supplied, and a discharge port through which the fluid is discharged. Microchannels are formed, by mounting the microchannel wall member to the mounting section and sealing the mounting section with the cover, define the microchannels, in which the fluid supplied through the supply port is discharged through the discharge port after being passed through the microchannels; and in corners of each of a bottom and an opening of the concave portions, an interface between the microchannel structure and the anodized film is formed into a curved shape as seen from a passage direction of the fluid of the microchannel.

### BRIEF DESCRIPTION OF THE SEVERAL VIEWS OF THE DRAWING

FIG. 1 is a block diagram showing a fuel cell system having a chemical reaction device according to an embodiment of the present invention;

FIG. 2 is an exploded perspective view schematically showing a chemical reaction device according to an embodiment of the present invention;

FIG. 3A is a plan view showing a microchannel wall member;

FIG. 3B is a side view showing the microchannel wall member;

FIG. 4A is a schematic partial sectional view showing convex and concave corners of a conventional microchannel wall member in an expanded state;

FIG. 4B is a schematic partial sectional view showing convex and concave corners of a microchannel wall member of the present invention in an expanded state;

FIG. 5 is a partial sectional view showing an anodized film of the concave corner of a bent shape to explain a film thickness measuring portion;

FIG. 6A is a characteristic diagram showing a distribution of a film thickness ratio tᵣ/tₐᵥₑ of various sample anodized films;

FIG. 6B is a table showing numerical data of a film thickness ratio tᵣ/tₐᵥₑ of the samples;

FIG. 7A is a micrograph showing a crack generated in the anodized film of the concave corner; and

FIG. 7B is a micrograph showing a part of FIG. 7A in a more expanded state.

### DETAILED DESCRIPTION OF THE INVENTION

The embodiments of the present invention will be described below with reference to the accompanying drawings.

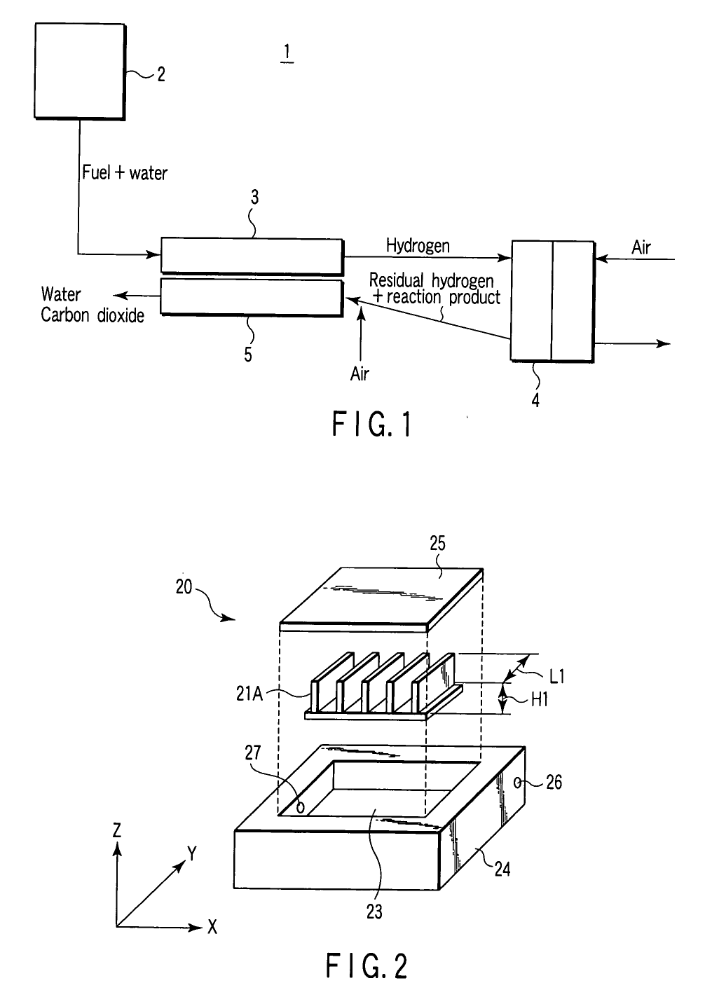

FIG. 1 is a block diagram of a fuel cell system which uses a chemical reaction device according to an embodiment of the present invention. A fuel cell system 1 includes a fuel tank 2, a reformer 3, a cell stack 4, a catalyst combustion reactor 5, and an air supply pump (not shown). Fuel sent from the fuel tank 2 is reformed by a chemical reaction device 20 in the reformer 3, and then sent to the cell stack 4 to be used for power generation.

The fuel tank 2 stores fuel for a fuel cell, e.g., a fluid mixture of dimethylether and water. For example, a detachable pressure container can be used for the fuel tank 2.

The reformer 3 promotes a reforming reaction to reform the fuel sent from the fuel tank into a gas (reformed gas) containing hydrogen. In this case, the fuel includes not only fuel of a liquid state but also fuel of a gasified state or a gas-liquid mixed state. In a case of the reformer 3, at least one or more chemical reaction devices 20 shown in FIG. 2 are installed. To increase efficiency of the fuel cell system 1, the outer periphery of the case of the reformer 3 is preferably covered with a heat insulating material to be insulated. In place of the insulating material of the outer periphery, the inside of the case of the reformer 3 may be lined with an insulating material, or a vacuum heat insulating layer may be formed in the case.

The reformer 3 is disposed in tight contact with the catalyst combustion reactor 5 to exchange heat. It receives reaction heat necessary for a reforming reaction from the catalyst combustion reactor 5 to be maintained at a temperature, e.g., 350° C., to generate a modification reaction. The catalyst combustion reactor 5 burns hydrogen and air contained in an off-gas discharged from the cell stack 4 and not used for power generation.

The cell stack 4 includes a plurality of fuel cells each constituted of an anode, a proton conductive semipermeable membrane, and a cathode (not shown). It introduces a modified gas from the reformer 3 to the anode, and air to the cathode by a pump (not shown) as air supply means to generate power. A structure of such a cell stack 4 is described in detail in, e.g., Patent No. 3413111 and Jpn. Pat. Appln. KOKAI No. 2004-234969, the entire of which are incorporated herein by reference.

Next, referring to FIGS. 2, 3A, 3B, and 4B, the chemical reaction device 20 of the embodiment will be described.

The chemical reaction device 20 includes a microchannel wall member 21A (part of microchannel structure) which has pluralities of convex portions 221A and concave portions 213A (channels) arranged at a pitch of several millimeters or less. A one end of channel and an other end of channel have an opening to the surface of the microchannel wall member 21A. The convex and concave portions 212A and 213A of the mirochannel wall member 21A are formed by using machining such as wire electric discharge machining or cutting. A catalyst is supported on at least a part of a surface of the convex and concave portions 212A and 213A.

The case 24 is provided with a mounting section 23 to mount the microchannel wall member 21A. The mounting section 23 has a rectangular planar shape and a predetermined depth. When the microchannel wall member 21A is mounted on the mounting section 23, and the mounting section 23 is covered with a cover 25, the entire microchannel wall member 21A is received in a box constituted of the case 24 and the cover 25. When necessary, the microchannel wall member 21A and the case 24 are bonded together, the case 24 and the cover 25 are bonded together, and the mounting section 23 is sealed. Accordingly, the mounting section 23 is designed to form a very small flow path (microchannel) in the box constituted of the case 24 and the cover 25.

As a microchannel structure, it is possible to employ a parallel structure in which a parallel flow is generated in a Y direction in the drawing, or a serpentine structure in which a flow path extending in the Y direction communicates with an adjacent microchannel at an end of the Y direction, causing fluid to meander at predetermined pitches in an X direction while reciprocating in the Y direction.

A supply port 26 is disposed in one side face of the case 4 to supply raw material (reactive fluid) to a microchannel. A discharge port 27 is disposed in an opposite side face of the case 24 to take out a reaction product and an unreacted object. The raw material flows through the supply port 26 into the microchannel, and is distributed in contact with a catalyst supported on the microchannel wall member 21A to generate a reaction product by a chemical reaction.

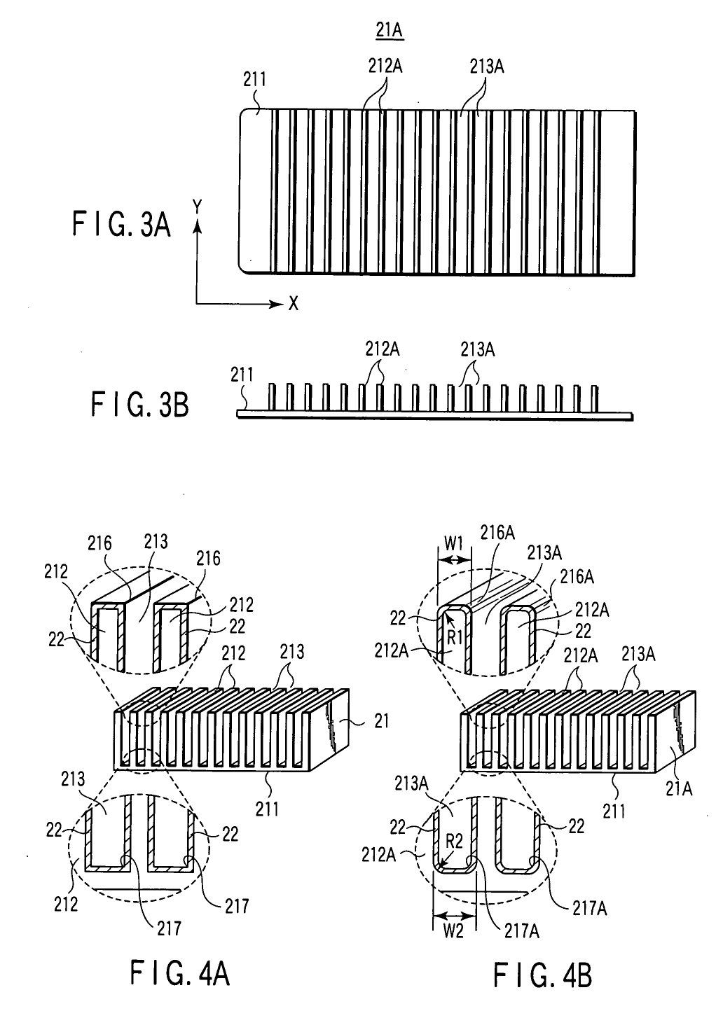

FIGS. 3A and 3B show the microchannel wall member 21A.

The microchannel wall member 21A is prepared by machining a base metal plate 211. To form a corrosion resistant film on a surface by anodizing, at least a part of the surface of the base metal plate 211 is preferably made of a material to be anodized. Additionally, to improve heat transmission characteristics during a catalytic reaction, a material of a high heat conductivity is preferably used for at least a part. A most preferable material to meet these requirements is aluminum (Al) or an aluminum alloy (e.g., Al—Mg alloy).

A case of using aluminum as a base material of the microchannel wall member will be described below.

As described in, e.g., Jpn. Pat. Appln. KOKAI No. 2004-154717, the entire of which are incorporated herein by reference, aluminum is anodized to form a porous body preferable as a catalyst support. When the microchannel wall member is actually subjected to anodizing, however, a problem occurs based on knowledge alone of the aforementioned document, creating an unfavorable situation. For example, in the case of the conventional anodizing of the planar aluminum plate material, an apparent area and a real treatment area are equal, and an anodized film can be formed at both current densities of 50 A/m² and 100 A/m² in oxalic acid bath. However, in the case of the anodizing of the microchannel wall member, a real area is larger by several to several tens of times than an apparent area. Thus, the anodizing is executed under excessive current density conditions as compared with the case of the planar plate. In other words, when there are thick and thin parts of the film, current concentration occurs in the thin part of the film, bringing about a very high probability of problem occurrence. To prevent this, a difference between an apparent area and a real area must be small as much as possible.

Meanwhile, however, as the microreactor is designed to arrange some chemical reaction processes in a predetermined very small space, certain constraints are imposed on its size. As a result, designing is supported out to enlarge a difference between an apparent area and a real area.

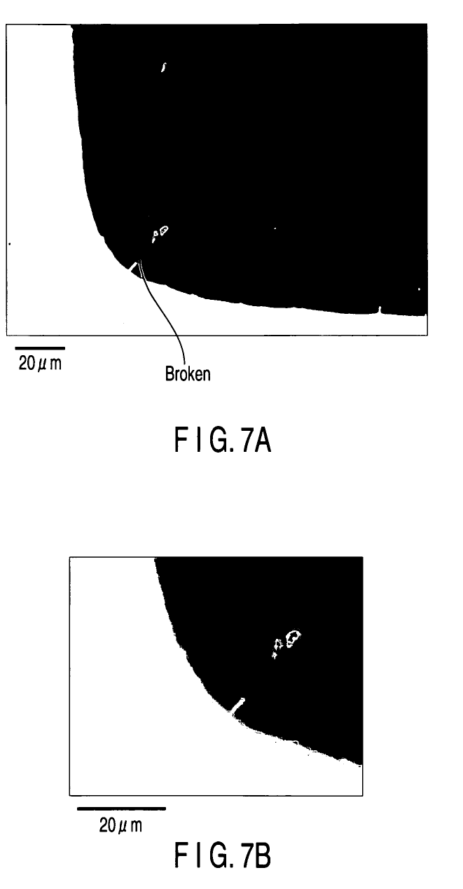

It is obvious here that simple formation of a microchannel as described in Jpn. Pat. Appln. KOKAI No. 2003-88754 (Patent Document 1) and Jpn. Pat. Appln. KOKAI No. 2003-301295 (Patent Document 2) is not enough. In the case of the conventional microchannel wall member, a nonuniform portion of the anodized film is constituted of corner portions 216, 217 of the microchannel, local stress concentrates in the thin corner of the film, and this is combined with a variance of film quality (hardness) to cause very small cracks similar to those shown in FIGS. 7A and 7B. A danger of destroying the film starting from the cracks is very high.

In the case of changing the design of the microchannel to avoid the corners, it is not clear how much the corners are avoided. Needless to say, a problem can be prevented to a certain extent by lowering a current density during the anodizing. However, this method is not practical, economical, or commercial because of a relation between a forming speed of the film and an erosion speed. When a current density is increased to 100 A/m² or more, a pore diameter of the formed oxide film is enlarged, and the film is hardened. Consequently, for example, as compared with the anodizing at 50 A/m², a problem of a reduction in the amount of a catalyst on a catalyst support occurs.

As a result of earnest studies by the inventors, it has been gradually clarified that when importance is put on compact and functional formation of the microreactor, certain constraints are imposed because of a relation between a microchannel shape to avoid corners and a current density to form an anodized film.

This point will be described below more in detail.

A height H1 of the convex portion (or depth of the concave portion) of the microchannel is preferably set large because an area of the flow path wall is larger as it is higher. However, when the height H1 is higher, the possibility that the convex portion will be bent to be deformed during machining is increased, and transmission of reaction heat from a wall surface to other surrounding members becomes difficult, easily generating a so-called hot spot. Therefore, the height H1 of the convex portion (or depth of the concave portion) of the microchannel is preferably set within a range of 3 mm or more to 20 mm or less.

A width W1 of the convex portion of the microchannel is narrower, the better. It is because more convex portions can be formed in a fixed volume, and more flow paths can be formed. However, when the width W1 of the convex portion is set less than 0.1 mm, problems similar to those described above (bent deformation of the convex portion, hot spot generation) occur. Thus, the width W1 of the convex portion of the microchannel is preferably set within a range of 0.1 mm or more to 1.0 mm or less. Most preferably, the width W1 of the convex portion is set within a range of 0.2 to 0.6 mm.

The narrow the width W2 of the concave portion of the microchannel is narrower, the better. It is because more concave portions can be formed in a fixed volume and more flow paths can be formed. However, when the width W2 of the concave portion is set less than 0.05 mm or less, not only introduction/discharging of a liquid which becomes a support for supporting a catalyst to/from the concave portion becomes difficult, but also a linear velocity of a reactive substance passed during running is increased, causing a reduction in reaction efficiency. Therefore, the width W2 of the concave portion of the microchannel is set within a range of 0.05 mm or more to 1.0 mm or less. Most preferably, the width W2 of the concave portion is set within a range of 0.4 to 0.8 mm.

Next, referring to FIGS. 4A and 4B, the microchannel of the embodiment will be described in comparison with a conventional microchannel.

In the case of the conventional microchannel shown in FIG. 4A, when the corner portions 216, 217 are formed sharp after the microchannel wall member 21 is anodized, i.e., an interface between the microchannel wall member 21 and the anodized film 22 is formed into a shape having no curve, a variance occurs in thickness of the anodized film 22, easily causing cracks in the film of a thin portion. When cracks occur in the anodized film along the convex corner portion 216 (ridgeline of convex portion 212) and the concave corner portion 217 (trough line of the concave portion 213), the base metal may be melted from the cracked portions, and all the base metals may be melted at the end.

On the other hand, in the case of the microchannel of the embodiment shown in FIG. 4B, when the corner portions 216A, 217A are formed curved after the mirochannel wall member 21A is anodized, i.e., an interface between the microchannel wall member 21A and the anodized film 22 is formed into a shape having a curve, a variance in film thickness of the anodized film 22 is reduced, preventing generation of cracks in the anodized film 22. As a result, the latter 21A is higher in yield than the former 21.

As specific conditions for the anodizing, the microchannel wall member is dipped in a 4% by mass oxalic acid solution, and a current density is less than 300 A/m², preferably less than 100 A/m², more preferably within a range of 15 to 75 A/m² at a room temperature of 25° C. However, an apparent area of a porous body is a reference for the current density.

In this case, by changing a curvature radius of the base material before the anodizing at the corner, a current density, a concentration, a temperature of a oxalic acid solution, and an amount of aluminum contained in the oxalic acid solution, it is possible to change a curvature radius of the interface between the anodized film 22 after the anodizing at the corner and the microchannel wall member 21A. Specifically, when the curvature radius of the base material before the anodizing at the corner is large, it is possible to increase the curvature radius of the interface between the anodized film 22 and the microchannel wall member 21A after the anodizing at the corner.

When the current density is large, it is possible to increase the curvature radius of the interface between the anodized film 22 after the anodizing at the corner and the microchannel wall member 21A.

When the concentration of the oxalic acid solution used for anodizing is high, it is possible to increase the curvature radius of the interface between the anodized film 22 after the anodizing at the corner and the microchannel wall member 21A.

When the temperature of the oxalic acid solution is high during anodizing, it is possible to increase the curvature radius of the interface between the anodized film 22 after the anodizing at the corner and the microchannel wall member 21A.

When the amount of aluminum contained in the oxalic acid solution is small, it is possible to increase the curvature radius of the interface between the anodized film 22 after the anodizing at the corner and the microchannel wall member 21A.

A size of a pore generated in the anodized film 22 is nanoscale. Accordingly, an actual current density is smaller than a numerical value of an apparent current density. A relation of S1/S2≧1 is established in which S1 is a real area of a porous body (including inner surface area of the hole) and S2 is an apparent area of the porous body (not including inner surface area of the hole). A current density is preferably set less than 100 A/m² when the aluminum or the aluminum alloys is anodized, most preferably within a range of 15 to 75 A/m². Treatment time cannot be decided uniformly because of an influence from base material quality, components, a concentration, and a temperature of the solution, or the like. However, as an indication, when the aluminum is anodized, treatment time is set to about 8 hours at a current density of about 100 A/m², and treatment time is about 16 hours at a current density of about 50 A/m².

In this case, anodizing conditions must be changed in accordance with a supporting amount (target supporting amount) of a catalyst per target unit area. Especially, in a “dipping method”, as a range of optimal conditions varies depending on base metals, treatment conditions including a current density must be changed. The target supporting amount is set based on designed performance of the fuel cell. On the other hand, how much the porous surface layer (anodized film 22) of the manufactured microchannel wall member can support the catalyst is obtained by repeating experiments for trials and errors. The obtained treatment conditions belong to know-how. The anodizing conditions can achieve the target supporting amount as much as possible.

Next, an example of the present invention will be described in comparison with a comparative example.

### EXAMPLES

Corner portions of a microchannel made of aluminum (JIS 1050 material) were R-chamfered to be radius of 0.20 mm, 0.10 mm, and 0.05 mm, thereby preparing three kinds of samples A1, B1, and C1 for examples. These samples A1, B1, and C1 were dipped in a 4% by mass oxalic acid solution, and subjected to anodizing under conditions of a temperature 25° C., a direct current density 25 to 50 A/m², and treatment time about 16 to 32 hours. In the case of the samples A1 and B1, a direct current density was 50 A/m² and treatment time was 16 hours. In the case of the sample C1, a DC current density was 25 A/m², and treatment time was 32 hours. Accordingly, porous oxide aluminum films having an average film thickness of 38 μm or more for the sample A1, an average film thickness of 37 μm for the sample B1, and an average film thickness of 42 μm or more for the sample C1 were formed.

### COMPARATIVE EXAMPLE

Corner portions of a microchannel made of aluminum (JIS 1050 material) was R-chamfered to be a radius of 0.05 mm to prepare a sample D1 for a comparative example. This sample D1 was subjected to anodizing under the same conditions as those of the samples A1, B1 (DC current density: 50 A/m²; treatment time: 16 hours). As a result, a porous oxide aluminum film of an average film thickness of 39 μm or more was formed.

The anodized samples A1, B1, C1, and D1 were embedded in resins, and cut to view anodized films 22. Cut sections were polished, and a film thickness of each anodized film 22 was measured by using an optical microscope. A curvature R2 of a corner of a concave portion 213A was measured based on sample section observation by a microscope.

(Measurement of Film Thickness or the Like)

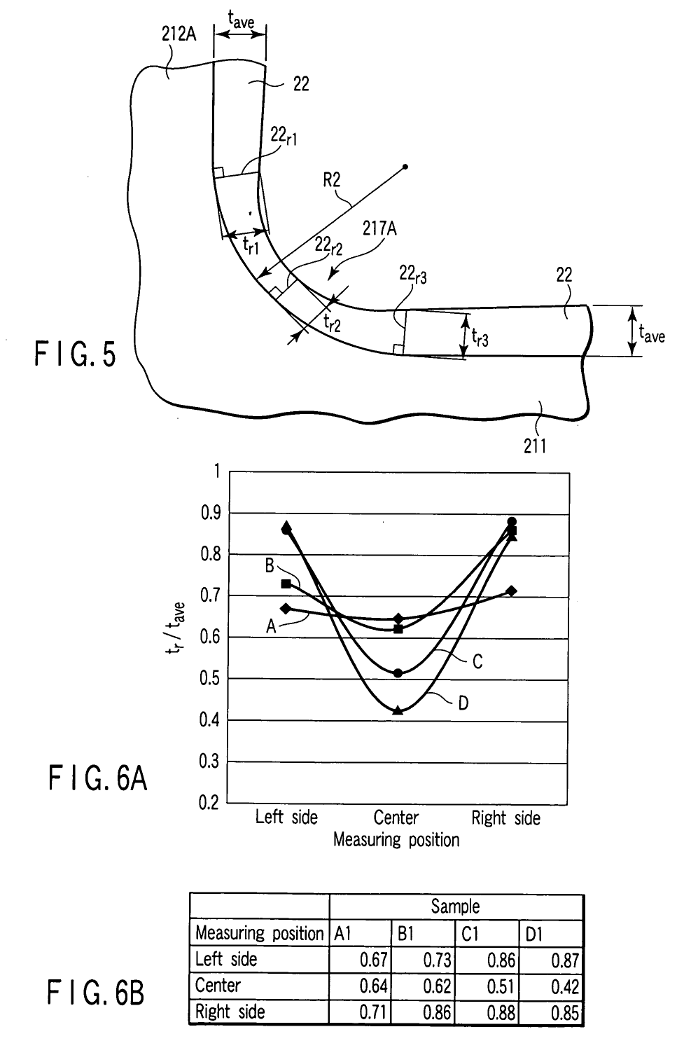

Referring to FIG. 5, a method of measuring a film thickness or the like of an anodized film will be described.

A left position 22r₁ and a right position 22r₃ in which a film thickness of the anodized film 22 steeply drops are found through microscopic observation, and a range from the left position 22r₁ to the right position 22r₃ is set as an R-chamfered portion of a concave corner 217A. Other portions are set as flat portions (non R-chamfered portions).

A film thickness tr₁ of the position 22r₁ and a film thickness tr₃ of the position 22r₃ are measured. Further, a film thickness tr₂ of a center position 22r₂ is measured. The center position 22r₂ is a center between the left position 22r₁ and the right position 22r₃. Normally, the film thickness tr₂ of the center position 22r₂ is a smallest film thickness of the anodized film 22.

A film thickness in each of a plurality of optional points (e.g., 6 points in total: 3 each left and right) of a flat portion is measured, and an arithmetic average thereof is set as an average film thickness tₐᵥₑ of the flat portion.

Furthermore, a curvature radius R2 of an R-chamfered portion is geometrically obtained from the left position 22r1 and the right position 22r₃. A circumference (not shown) of the curvature radius R contacts or overlaps an interface between the film 22 and the base material.

(Evaluation Test)

Curvature radiuses R2 of boundaries between the anodized films 22 and the microchannel wall members 21A of the samples A1, B1 for the examples, and C1 were respectively 0.238 mm, 0.130 mm, and 0.049 mm, while a curvature radius R2 of a boundary between the anodized film 22 of the sample D1 for the comparative example and the microchannel wall member 21A was 0.041 mm.

For each of the samples A1, B1, C1, and D1, a predetermined supporting amount of a platinum (Pt) catalyst was supported, and incorporated in a fuel cell system. The system was actually run to check durability of a catalyst supporting layer (anodized film 22). For a method of supporting a catalyst, an impregnation method was used. In the impregnation method, the sample was dipped in a catalyst containing solution, pulled from the solution after a passage of predetermined time, and heated and burned.

In the case of the sample D1 for the comparative example, it was confirmed that cracks occurred in the anodized film 22 of the corner when a curvature radius of the boundary between the anodized film 22 after anodizing and the microchannel wall member 21A was less than 0.049 mm. On the other hand, in the samples A1, B1, C1, and D1 for the examples, no cracks occurred when each curvature radius of the boundary between the anodized film 22 after anodizing and the microchannel wall member 21A was equal to or more than 0.049 mm.

FIG. 6A is a characteristic diagram showing changes in film thickness of the anodized films 22 of the corners for the samples A1, B1, and C1 for the examples and the sample D1 for the comparative example, in which an abscissa indicates a film thickness measuring section and an ordinate indicates a film thickness ratio tᵣ/tₐᵥₑ of a film thickness tᵣ of the corner with respect to an average film thickness tₐᵥₑ of the flat portion. In the drawing, a characteristic line A indicates a film thickness measuring result of the sample A1 (R2=0.238 mm) for the example, a characteristic line B indicates a film thickness measuring result of the sample B1 (R2=0.130 mm) for the example, a characteristic line C indicates a film thickness measuring result of the sample C1 (R2=0.049 mm) for the example, and a characteristic line D indicates a film thickness measuring result of the sample D1 (R2=0.041 mm) for the comparative example. FIG. 6B shows numerical data of film thickness ratios tᵣ/tₐᵥₑ of the samples A1, B2, C1, and D1. Numerical values of FIG. 6B are values of film thickness ratios tᵣ/tₐᵥₑ.

In the case of the sample D1 for the comparative example, as indicated by the characteristic line D, it was confirmed that cracks occurred in the anodized film of the corner when a film thickness ratio tᵣ/tₐᵥₑ was less than 0.51. As shown in expansion in FIG. 7B, it was observed that the cracks penetrated the full thickness of the anodized film and the cracks had considerable voids.

On the other hand, in the case of the samples A1, B1, and C1 for the examples, as indicated by the characteristic lines A, B, and C, a film thickness tᵣ/tₐᵥₑ was equal to or more than 0.51, and no cracks occurred at all.

As a result of the durability test, in the case of the samples A1, B1, and C1 for the examples, no cracks occurred at the corners of the catalyst supporting layers, and long-time continuous running was possible.

The foregoing result has demonstrated that there is a quantitative correlation between the curvature radius of the boundary between the anodized film 22 and the microchannel wall member 21A at the corner of the microchannel and the occurrence of cracks, and setting of the curvature radius to a fixed value or more is advantageous.

Table 1 shows a relation between anodizing conditions and a film thickness in the examples and the comparative example.

TABLE 1
Relation between anodizing
conditions and film thickness

| | | | Average film |
|---|---|---|---|
| Base | | Current density, | thickness |
| metal | Solution | temperature | (μm) |
| Aluminum | 4% oxalic | DC 25 or 50 A/m² | 37 μm or |
| | acid | temperature 25° C. | more |

Table 2 shows an evaluation result of the examples and the comparative example.

TABLE 2
Relation among curvature radius of
corner portion, average film thickness of
flat portion, and occurrence of cracks

| | Average film | |
|---|---|---|
| Curvature radius | thickness of | Presence of cracks |
| after anodizing | flat portion | in anodized layer |
| R (mm) | tₐᵥₑ (μm) | of corner portion |
| 0.238 | 38 | None |
| 0.130 | 37 | None |
| 0.049 | 42 | None |
| 0.041 | 39 | Yes |

The present invention provides a chemical reaction device which has a microchannel structure suited to miniaturization and having high mass productivity without generating cracks in an anodized film. The invention provides a fuel cell system which generates power by using hydrogen modified by such a chemical reaction device.

Additional advantages and modifications will readily occur to those skilled in the art. Therefore, the invention in its broader aspects is not limited to the specific described herein. Accordingly, various modifications may be made without departing from the spirit or scope of the general inventive concept as defined by the appended claims and their equivalents.

What is claimed is:

1. A chemical reaction device comprising:
a microchannel wall member having a surface at least a part of which is made of a material to be anodized, and having a plurality of concave portions adjacent to each other;
an anodized film formed in at least a part of the concave portions;
a container having a mounting section disposed in order to mount the microchannel wall member thereto;
a cover mounted on the container to seal the mounting section;
a supply port through which a fluid is supplied; and
a discharge port through which the fluid is discharged,
wherein:
microchannels are formed, by mounting the microchannel wall member to the mounting section and sealing the mounting section with the cover, define the microchannels, in which the fluid supplied through the supply port is discharged through the discharge port after being passed through the microchannels; and
in a corner of each of a bottom and an opening of the concave portions, an interface between the microchannel wall member and the anodize film is formed into a curved shape as seen from a passage direction of the fluid of the microchannels.

2. The chemical reaction device according to claim 1, wherein a curvature radius of the curved shape is 0.049 mm or more.

3. The chemical reaction device according to claim 1, wherein in the anodized film, a ratio tᵣ/tₐᵥₑ of a film thickness tᵣ of a smallest film thickness portion of the corner with respect to an average film thickness tₐᵥₑ at a flat of the inner wall is 0.51 or more.

4. The chemical reaction device according to claim 1, wherein the material to be anodized is aluminum or an aluminum alloy.

5. The chemical reaction device according to claim 1, wherein the concave portions defining the microchannels, each of widths of the convex portions and the concave portions is 1 mm or less.

6. A fuel cell system comprising:
a fuel tank which stores a fluid fuel;
a reformer having a chemical reaction device to reform the fluid fuel sent from the fuel tank; and
a fuel cell system which includes an anode, a proton conductive semipermeable membrane, and a cathode, and introduces a gas reformed by the chemical reaction device to the anode and air to the cathode to generate power,
wherein:
the chemical reaction device comprises
a microchannel wall member having a surface at least a part of which is made of a material to be anodized, and having a plurality of concave portions adjacent to each other,
an anodized film formed in at least a part of the concave portions,
a container having a mounting section disposed in order to mount the microchannel wall member thereto,
a cover mounted on the container to seal the mounting section,
a supply port through which a fluid is supplied, and
a discharge port through which the fluid is discharged;
microchannels are formed, by mounting the microchannel wall member to the mounting section and sealing the mounting section with the cover, define the microchannels, in which the fluid supplied through the supply port is discharged through the discharge port after being passed through the microchannel; and
in corners of each of a bottom and an opening of the concave portions, an interface between the microchannel structure and the anodized film is formed into a curved shape as seen from a passage direction of the fluid of the microchannel.

7. The fuel cell system according to claim 6, wherein a curvature radius of the curved shape is 0.049 mm or more.

8. The fuel cell system according to claim 6, wherein in the anodized film, a ratio tᵣ/tₐᵥₑ of a film thickness tᵣ of a smallest film thickness portion of the corner with respect to an average film thickness tₐᵥₑ at a flat of the inner wall is 0.51 or more.

9. The fuel cell system according to claim 6, wherein the material to be anodized is aluminum or an aluminum alloy.

10. The fuel cell system according to claim 6, wherein the concave portions defining the microchannels, each of widths of the convex portions and the concave portions is 1 mm or less.
